(19) United States
(12) Patent Application Publication
(10) Pub. No.: US 2009/0286049 A1
(43) Pub. Date: Nov. 19, 2009

(54) METHODS OF APPLYING UV-CURABLE INKS TO RETROREFLECTIVE SHEETING

(75) Inventors: Bran W. McFarland, River Falls, WI (US); Bruce A. Nerad, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/121,170

(22) Filed: May 15, 2008

(51) Int. Cl. B32B 33/00; B05B 5/00

(52) U.S. Cl. 428/195.1; 427/160

(57) ABSTRACT

The present application relates to methods of forming a signage including a radiation curable ink. One exemplary embodiment involves heating at least a portion of a retroreflective article; applying a radiation curable ink to the heated portion of the retroreflective article; and curing the radiation curable ink. In most instances, a heated retroreflective article has a temperate that is greater than room temperature.

### TECHNICAL FIELD

The present application relates generally to methods of applying UV inks to retroreflective sheeting.

### BACKGROUND

Two known types of retroreflective sheeting are microsphere-based sheeting and cube corner sheeting. Microsphere-based sheeting, sometimes called “beaded” sheeting, employs a multitude of microspheres typically at least partially imbedded in a binder layer and having associated specular or diffuse reflecting materials (e.g., pigment particles, metal flakes, vapor coats) to retroreflect incident light. Cube corner retroreflective sheeting comprises a body portion typically having a substantially planar front surface and a rear structured surface comprising a plurality of cube corner elements. Each cube corner element comprises three approximately mutually perpendicular optical faces that cooperate to retroreflect incident light.

Ink jet printing is emerging as the digital printing method of choice due to its good resolution, flexibility, high speed, and affordability. Ink jet printers operate by ejecting, onto a receiving substrate, controlled patterns of closely spaced ink droplets. By selectively regulating the pattern of ink droplets, ink jet printers can produce a wide variety of printed features, including, for example, text, graphics, bar codes, and the like.

The inks most commonly used in ink jet printers are water-based or solvent-based. Water-based inks require porous substrates or substrates with special coatings that absorb water. On the other hand, solvent-based inks typically contain about 90% organic solvents. Since manufacturers prefer to reduce solvent emissions, the evaporation of large quantities of solvent during ink drying is undesirable. Further, the drying process can be the rate-limiting step for ink jet printing, reducing production rates.

In order to avoid the problems associated with water-based and solvent-based inks, radiation-curable ink compositions comprising polymerizable ingredients have been developed. The polymerizable ingredients not only function as a solvent by reducing the viscosity of the composition prior to curing, but also function as a binder when cured, and optionally as a crosslinking agent. In the uncured state, these compositions have low viscosities and are readily ink jettable. The polymerizable ingredients readily react upon exposure to a suitable radiation source (e.g., ultraviolet light or electron beam) to form a crosslinked polymer network. The use of radiation curing allows the inks to “dry instantly” per se in view of the rapidity in which the composition can be radiation cured.

However, one problem with radiation curable inks is that these ink compositions do not uniformly adhere to all substrates. Acceptable adhesion to retroreflective substrates has been especially challenging to achieve. Attempts to address this challenge include modifying the ink composition for optimized adhesion on the substrate of interest.

### SUMMARY

There is a continuing need to improve the performance, reduce the cost, and to simplify the manufacture of retroreflective signage. The present application addresses at least some of these needs.

For example, the present application describes a method of forming a signage comprising: heating at least a portion of a retroreflective sheeting; applying a UV-curable ink to at least a portion of the heated retroreflective sheeting; and curing the UV-curable ink.

Also, the present application describes a method of forming an imaged article comprising: heating at least a portion of a retroreflective substrate; applying a radiation-curable ink onto at least a portion of the heated retroreflective substrate; and curing the ink to form the imaged article.

The present application also describes a signage formed by the methods described above.

### DETAILED DESCRIPTION

The term “signage” as used herein refers to a stand-alone article that conveys information, usually by means of alphanumeric characters, symbols, graphics, or other indicia. Specific signage examples include, but are not limited to, signage used for traffic control purposes, street signs, and vehicle license plates.

The term “retroreflective” as used herein refers to the attribute of reflecting an obliquely incident light ray in a direction antiparallel to its incident direction, or nearly so, such that it returns to the light source or the immediate vicinity thereof. The retroreflective sheeting, films, or articles described herein may be either beaded or prismatic.

The term “ink jetted image” and “ink jet printed” both refer to an image created with an ink jet printing process employing a radiation curable ink composition. The image may be text, graphics, coding (e.g., bar coding), etc., being comprised of a single color, multiple colors, or being unapparent in the visible light spectrum.

The term “radiation curable” refers to functionality directly or indirectly pendant from a monomer, oligomer, or polymer backbone (as the case may be) that react (e.g., crosslink) upon exposure to a suitable source of curing energy.

The term “monomer” means a relatively low molecular weight material (i.e., having a molecular weight less than about 500 g/mole).

The term “polymer” means a molecule comprising a substructure formed from one or more monomeric, oligomeric, and/or polymeric constituents having repeating monomer substructure and that has no further radiation polymerizable groups.

One exemplary embodiment of the present application relates to a method of forming a signage by heating at least a portion of a retroreflective article; applying a radiation curable ink to the heated portion of the retroreflective article; and curing the radiation curable ink. Thus a radiation curable ink is applied to at least a portion of a heated retroreflective article. In most instances, the heated retroreflective article has a temperate that is greater than room temperature. The specific preferred temperature will depend on the retroreflective article, the process of applying the ink, the method of curing, and the intended use of the article. That said, exemplary preferred temperatures include, but are not limited to, those that are greater than 97° F. (36° C.), and more preferably those that are greater than 110° F. (43° C.).

In one exemplary implementation, the retroreflective article is a sheet or film having two major surfaces: a first major surface and a second major surface. Radiation curable ink is applied to at least a portion of at least one of the two major surfaces. In some exemplary implementations, radiation curable ink may be applied to both the first and second major surfaces. Such application may occur by any method known in the art, including, for example, digital printing or ink jet printing. Exemplary printers include, for example, a piezo UV ink jet printer including flat bed, roll-to-roll, or sheet fed styles or models. The use of ink jet printers and/or digital printing to make signages may reduce manufacturing costs by, for example, reducing total labor content of signages (especially signage having complex or custom images), replacing expensive and time-consuming screen printing, reducing manufacturing cycle time, increasing short run production capability, reducing inventory, and improving productivity. One study has shown that for production of a complex multi-color overhead type guide sign, labor content can be reduced by as much as 75% with a digital work flow and UV ink jet printing.

The radiation curable ink is then cured to form an article including a radiation cured image. The energy source used for achieving crosslinking of the radiation curable ink may be actinic (e.g., radiation having a wavelength in the ultraviolet or visible region of the spectrum), accelerated particles (e.g., electron beam radiation), thermal (e.g., heat or infrared radiation), or the like. In some embodiments, the preferred energy source is actinic radiation or accelerated particles, because such energy provides excellent control over the initiation and rate of crosslinking. Additionally, actinic radiation and accelerated particles can be used for curing at relatively low temperatures which avoids degrading components that might be sensitive to the relatively high temperatures that might be required to initiate crosslinking of the radiation curable groups when using thermal curing techniques. Suitable sources of actinic radiation include mercury lamps, xenon lamps, carbon arc lamps, tungsten filament lamps, lasers, electron beam energy, sunlight, and the like.

In some implementations, ultraviolet radiation, especially from medium pressure mercury lamps, is preferred. The inks that are cured using UV radiation may benefit from the presence of at least one photoinitiator. In the case of electron beam curing, however, photoinitiators are not required. The type of photoinitiator used depends on the choice of colorant in the ink composition and on the wavelength of the radiation. Commercially available free-radical generating photoinitiators include, but are not limited to benzophenone, benzoin ether, and acylphosphine photoinitiators such as those commercially available from Ciba Specialty Chemicals under the trade designations “Irgacure” and “Darocur”. The radiation curable ink may also be self-crosslinking.

In some exemplary implementations, a protective layer such as, for example, an overcoat, overlay, overlaminate, laminate, clear coat, varnish, or the like, is applied to the retroreflective article after the article has been cured. The protective layer may be or may include a pressure sensitive adhesive, and some exemplary pressure sensitive adhesives are described in U.S. patent application Ser. No. 11/875,894 entitled HIGH REFRACTIVE INDEX PRESSURE-SENSITIVE ADHESIVES and which is assigned to the assignee of the present application. The protective layer may be applied as, for example, a coating, pressure sensitive adhesive, a laminate, or a hot melt. A preferred protective layer will (1) maximize the coefficient of retroreflection; (2) protect the ink and substrate; and (3) adhere to the UV ink surface and to the retroreflective substrate. The protective layer may offer additional features, such as graffiti resistance. Clear, transparent, or semi-transparent protective layers are preferred for some implementations. Exemplary protective layers include, for example, substances including acrylics, urethanes, and epoxies, poly vinyl chlorides, polyesters, and partially or fully fluorinated materials. In at least some implementations, the application of a clear and relatively smooth protective layer over the cured ink facilitates retention of the retroreflectivity at the desired observer angle consistent with the transparency of the inks being applied.

In at least some preferred embodiments, the index of refraction of the ink and of the protective layer are within 10% of one another, more preferably within 5% of one another, and most preferably within 2% of one another. By matching the index of refraction of the ink and the protective layer, the retroreflectivity of the sheeting may be maintained or improved. In one exemplary implementation, a UV-curable ink has an index of refraction of approximately 1.51 to 1.54. The index of refraction of an exemplary acrylate PSA is approximately 1.47. The protective layer may provide maintained or enhanced retroreflectivity to the cured image on the sheeting and/or may provide maintained or enhanced durability to the cured image on the sheeting. More than one protective layer may be applied to the cured image.

In some exemplary implementations, the second major surface may be adjacent to a layer of pressure sensitive adhesive protected by a release liner. The release liner may be removed and the imaged substrate (e.g., the sheeting or film) may be adhered to a target surface such as, for example, a sign backing or substrate (e.g., metal or nonmetal), license plate backing or substrate, license plate, billboard, automobile, truck, airplane, building, awning, window, floor, or the like.

In some exemplary implementations, the process of applying a radiation curable ink to the heated sheeting results in an imaged article having the same or increased retroreflectivity as the portion of the sheeting to which no ink was applied. Because the temperature to which the retroreflective article is heated at the time the ink is applied may contribute to the retroreflectivity of the imaged article, the user can choose the temperature of the retroreflective article when the ink is applied to achieve a desired retroreflectivity of the imaged article.

Any radiation or UV-curable ink that includes at least one radiation curable polymer, oligomer, macromonomer, monomer, or mixture thereof and that provides acceptable ink adhesion and image quality may be employed in the methods and articles described in the present application. Consequently, a variety of radiation curable ink compositions can be employed. The radiation curable ink composition may be, but does not have to be, self-crosslinking. The chosen ink may be applied to the entire surface of the retroreflective article, substrate, film, or sheeting or only a portion thereof. The radiation curable ink compositions may comprise a single radiation curable monomer, oligomer, macromonomer, or polymer or various mixtures of such components. The radiation curable ingredient may be mono-, di-, tri-, tetra- or otherwise multifunctional in terms of radiation curable moieties. Provided that at least one of the ingredients is radiation curable, the radiation curable ink composition may include non-radiation curable ingredients.

The optimal viscosity characteristics for a particular ink composition will depend upon the desired application parameters including application temperature and the type of ink application system that will be used to apply the ink composition to the retroreflective article, substrate, sheet, or film. Exemplary inks that are preferred for some ink jet applications have a viscosity between about 3 centipoise and about 30 centipoise at the print head temperature.

Exemplary ink compositions that are preferred for some ink jet applications have moderate to low surface tension properties prior to curing. Exemplary preferred formulations have a surface tension in the range of from about 20 mN/m to about 50 mN/m and more preferably in the range of from about 22 mN/m to about 40 mN/m at the print head temperature. Some exemplary preferred inks may include a liquid component that diffuses into the surface of the retroreflective article, substrate, sheet, or film. The ink may further comprise at least one of a high Tg component, a multifunctional monomer, a low surface tension component, a gloss component, and mixtures thereof. Some preferred inks are substantially free of solvent.

The ink composition may comprise a variety of optional additives. Such optional additives include one or more flow control agents, photoinitiators, colorants, slip modifiers, thixotropic agents, foaming agents, antifoaming agents, flow or other rheology control agents, waxes, oils, polymeric materializers, binders, antioxidants, photoinitiator stabilizers, gloss agents, fungicides, bactericides, organic and/or inorganic filler particles, leveling agents, opacifiers, antistatic agents, dispersants, and the like. To enhance durability of a printed image graphic, especially in outdoor environments exposed to sunlight, a variety of commercially available stabilizing chemicals can be added optionally to the ink compositions including, but not limited to, heat stabilizers, ultra-violet light stabilizers, and free-radical scavengers.

Some preferred ink compositions are at least as flexible as the substrate. “Flexible” refers to the physical property wherein an imaged portion of the substrate having a thickness of 50 microns can be creased at 25° C. without any visible cracks in the ink.

Some exemplary ink composition (with the exception of ink compositions containing opaque colorants such as carbon black, titanium dioxide, or organic black dye) may be transparent when measured according to ASTM 810 Standard Test Method for Coefficient of Retroreflection of Retroreflective Sheeting. That is, when coated onto a retroreflective substrate, the visible light striking the surface of the film is transmitted through to the retroreflective sheeting components. This property makes the article particularly useful for outdoor signing applications in particular traffic control signing systems. Further, the dried and/or cured ink composition may be substantially non-tacky such that the printed image is resistant to dirt build-up and the like. For embodiments benefiting from enhanced durability for outdoor usage, the ink composition may preferably be aliphatic, being substantially free of aromatic ingredients. In some applications, polyurethane and/or acrylic based primer compositions are preferred.

Representative ink jet compositions for use in the invention include ink compositions described in U.S. Pat. Nos. 5,275,646, 5,981,113, and 6,720,042 which are hereby incorporated by reference and International Patent Application Nos. WO 97/31071 and WO 99/29788.

Suitable materials for use as the substrate are retroreflective materials, including, but not limited to, various films and sheetings, preferably comprised of thermoplastic or thermosetting polymeric materials. The methods of the present application may be particularly advantageous for low surface energy substrates. “Low surface energy” refers to materials having a surface tension of less than about 50 dynes/cm (also equivalent to 50 milliNewtons/meter). Some preferred polymeric substrates are nonporous. However, microporous, apertured, as well as substrates including water-absorbing particles (such as silica and/or super-absorbent polymers) may also be employed provided the substrate does not deteriorate or delaminate upon exposure to water and temperature extremes. Other suitable substrates include woven and nonwoven fabrics, particularly those comprised of synthetic fibers such as polyester, nylon, and polyolefins.

Representative examples of polymeric materials (e.g., sheet, films) for use as the substrate include, but are not limited to, single and multi-layer constructions of acrylic-containing films (e.g., poly(methyl) methacrylate [PMMA]), poly(vinyl chloride)-containing films, (e.g., vinyl, polymeric materialized vinyl, reinforced vinyl, vinyl/acrylic blends), poly(vinyl fluoride) containing films, urethane-containing films, melamine-containing films, polyvinyl butyral-containing films, polyolefin-containing films, polyester-containing films (e.g., polyethylene terephthalate) and polycarbonate-containing films. Further, the substrate may comprise copolymers of such polymeric species.

Exemplary commercially available films include a multitude of films typically used for signage uses such as, for example, those available from 3M under the trade designations “DG³,” “Diamond Grade,” “High Intensity Prismatic,” and “Engineer Grade.”

Depending of the choice of polymeric material and thickness of the substrate, the substrate (e.g., sheets, films) may be rigid or flexible. The substrate (e.g., sheet, film, polymeric material) may be clear, translucent, or opaque. Further, the substrate may be colorless, comprise a solid color, or comprise a pattern of colors. Additional information about substrates for use in connection with the methods and signage described herein can be found in U.S. Pat. No. 6,720,042 which is hereby incorporated by reference.

At least some preferred signage articles are durable for outdoor usage. “Durable for outdoor usage” refers to the ability of the article to withstand temperature extremes, exposure to moisture ranging from dew to rainstorms, and colorfast stability under sunlight's ultraviolet radiation. The threshold of durability is dependent upon the conditions to which the article is likely to be exposed and thus can vary. At minimum, however, the articles do not delaminate or deteriorate when submersed in ambient temperature (25° C.) water for 24 hours, nor when exposed to temperatures (wet or dry) ranging from about −40° C. to about 60° C. (140° F.).

In the case of signage for traffic control, the articles are preferably sufficiently durable such that the articles are able to withstand at least one year and more preferably at least three years of weathering. This can be determined with ASTM D4956-99 Standard Specification of Retroreflective Sheeting for Traffic Control that describes the application-dependent minimum performance requirements, both initially and following accelerated outdoor weathering, of several types of retroreflective sheeting. Initially, the reflective substrate meets or exceeds the minimum coefficient of retroreflection. For Type I white sheetings (“engineering grade”), the minimum coefficient of retroreflection is 70 cd/fc/ft² at an observation angle of 0.2° and an entrance angle of −4°, whereas for Type III white sheetings (“high intensity”) the minimum coefficient of retroreflection is 250 cd/fc/ft² at an observation angle of 0.2° and an entrance angle of −4°. In addition, minimum specifications for shrinkage, flexibility adhesion, impact resistance and gloss are preferably met. After accelerated outdoor weathering for 12, 24, or 36 months, depending on the sheeting type and application, the retroreflective sheeting preferably shows no appreciable cracking, scaling, pitting, blistering, edge lifting, or curling, or more than 0.8 millimeters shrinkage or expansion following the specified testing period. In addition, the weathered retroreflective articles preferably exhibit at least the minimum coefficient of retroreflection and colorfastness. For example, Type I “engineering grade” retroreflective sheeting intended for permanent signing applications retains at least 50% of the initial minimum coefficient of retroreflection after 24 months of outdoor weathering and Type III high intensity type retroreflective sheeting intended for permanent signing applications retains at least 80% of the initial minimum coefficient of retroreflection following 36 months of outdoor weathering in order to meet the specification. The coefficient of retroreflection values, both initially and following outdoor weathering, are typically about 50% lower in view of the presence of the radiation cured ink jetted image on the retroreflective substrates.

The imaged article is suitable for use as roll-up signs, flags, banners and other articles including other traffic warning items such as, for example, roll-up sheeting, cone wrap sheeting, post wrap sheeting, barrel wrap sheeting, license plate sheeting, barricade sheeting, and sign sheeting; vehicle markings and segmented vehicle markings; pavement marking tapes and sheeting; as well as retroreflective tapes. The article is also useful in a wide variety of retroreflective safety devices including, for example, articles of clothing, construction work zone vests, life jackets, rainwear, logos, patches, promotional items, luggage, briefcases, book bags, backpacks, rafts, canes, umbrellas, animal collars, truck markings, trailer covers, and curtains. The coefficient of retroreflection of the viewing surface for each of these articles will depend on the desired properties of the finished article.

In embodiments where the film, sheeting, or imaged article is likely to be exposed to moisture, the cube corner retroreflective elements may be encapsulated with a seal film. In instances wherein cube corner sheeting is employed as the retroreflective layer, a backing layer may be present for the purpose of opacifying the laminate or article, improving the scratch and gouge resistance thereof, and/or eliminating the blocking tendencies of the seal film. Illustrative examples of cube corner-based retroreflective sheeting are disclosed in U.S. Pat. Nos. 5,138,488; 5,387,458; 5,450,235; 5,605,761; 5,614,286; and 5,691,846. Illustrative examples of beaded retroreflective sheeting are disclosed in U.S. Pat. Nos. 4,025,159; 4,983,436; 5,064,272; 5,066,098; 5,069,964; and 5,262,225.

Objects and advantages of the invention are further illustrated by the following examples, but the particular materials and amounts thereof recited in the examples, as well as other conditions and details, should not be construed to unduly limit the invention. All parts, percentages and ratios herein are by weight unless otherwise specified. All of the following examples include the use of an ink jet printer sold by 3M under the trade name “3M Print 2500 UV Printer” was set up as follows. However, those of skill in the art will appreciate that other printer manufacturers, including, for example, Durst, could be used.

A heating assembly was placed on the front platen of the printer. The heating assembly comprised a 12 inches by 24 inches (30.48 cm by 60.96 cm) heating pad with a power density of 2.4 watt per square inch (manufactured and sold by BH Thermal Corporation of Ohio, United States under the trade designation “BriskHeat SRL 1224 Silicone Rubber Heating Blanket”) disposed between two aluminum plates, each having a thickness of about ⅛ inch (0.3175 cm). The heating pad and aluminum plates were held together by means of a metal clip. A single phase transformer manufactured and sold by McMaster-Carr of Ohio, United States under the trade designation “Bench Top Variable Voltage Output Transformer” having 120V input, 0-120 V output, and 12 amp was connected to the heating pad and used to adjust the voltage, and consequently the temperature, of the heating pad.

The following three inks were placed in their respective locations in the printer (except the red ink was placed in the magenta position): red ink commercially available under the trade designation “3M Piezo Ink Jet Ink Series 8812 UV Red” sold by 3M Company; yellow ink commercially available under the trade designation “3M Piezo Ink Jet Ink Series 8814 UV Yellow” sold by 3M Company; and cyan ink commercially available under the trade designation “3M Piezo Ink Jet Ink Series 8816 UV Cyan” sold by 3M Company. Using the fill levels shown in Table I, the printer was capable of printing the following four colors: Traffic Red, Traffic Yellow, Traffic Blue, and Traffic Orange.

TABLE I
Fill Levels

| Traffic Color | Cyan | Red | Yellow |
|---|---|---|---|
| Red | None | 70M | None |
| Blue | 100C | None | None |
| Orange | None | 18M | 80Y |
| Yellow | None | 4M | 100Y |

A test pattern was created using Adobe Illustrator® software. The test pattern included four 4×9 inch (10.2 cm by 22.86 cm) rectangles printed adjacent to one another and separated by approximately ½ inch (1.27 cm). One of the rectangles was printed in each of the following four colors: Traffic Red, Traffic Yellow, Traffic Blue, and Traffic Orange. The RIP settings were: test chart mode with a spot size of 1 for all colors and a resolution of 726 by 600 dots per inch (dpi). The test pattern file was translated to a printable file by software manufactured by 3M Company and commercially sold under the trade name “3M Graphic Maker RIP.”

### EXAMPLE 1

A piece of prismatic retroreflective sheeting (manufactured and sold by 3M Company of St. Paul, Minn. under the trade designation “3M Diamond Grade™”) that measured approximately 12 by 20 inches (30.5 cm by 50.8 cm) was placed on the uppermost aluminum plate of the printer described above and was allowed to warm. When the prismatic sheeting reached a desired start temperature, the above-described test pattern was printed on the prismatic sheeting using the above-described printer in a two-pass XY printing mode set at 726 by 600 dpi resolution. The two UV lamps in the printer were set on high and were operated in leading “L” (gloss) cure mode. Using a handheld digital thermometer (manufactured by Omega Engineering Inc. of Connecticut, United States and sold under the trade designation “HH81” and equipped with a thermocouple), the temperature of the prismatic sheeting was measured immediately before (designated in Table II as “Start Temp.”) and immediately after (designated in Table II as “End Temp.”) printing the image. It took approximately two minutes for the print head to print the test pattern on the prismatic sheeting.

To determine how well the ink adhered to the prismatic sheeting, the percent adhesion was measured according to the procedure described in ASTM D-3359-95 Standard Test Methods for Measuring Adhesion by Tape Test, using one inch (2.54 cm) wide adhesive tape manufactured and sold by 3M Company under the trade designation “3M 232 Masking Tape.” Table II below shows the results of the percent adhesion test for each color that was applied to the prismatic sheeting at various temperatures.

TABLE II
Adhesion by Tape Test Results at Various Temperatures

| Test | Start | End | Percent Adhesion (%) | | | |
|---|---|---|---|---|---|---|
| Number | Temp (° F.) | Temp (° F.) | Red | Orange | Yellow | Blue |
| 1 | 72 | 79 | 12 | 0 | 0 | 0 |
| 2 | 72 | 79 | 2 | 0 | 0 | 0 |
| 3 | 72 | 79 | 56 | 0 | 0 | 2 |
| 4 | 72 | 79 | 0 | 0 | 0 | 3 |
| 5 | 72 | 79 | 2 | 0 | 0 | 0 |
| 6 | 72 | 79 | 1 | 0 | 0 | 9 |
| 7 | 97 | 104 | 98 | 0 | 0 | 80 |
| 8 | 97 | 104 | 98 | 0 | 2 | 64 |
| 9 | 97 | 104 | 95 | 0 | 6 | 95 |
| 10 | 110 | 114 | 99 | 94 | 80 | 99 |
| 11 | 110 | 114 | 99 | 96 | 42 | 99 |
| 12 | 110 | 114 | 99 | 92 | 36 | 99 |
| 13 | 125 | 130 | 100 | 99 | 98 | 100 |
| 14 | 125 | 130 | 100 | 99 | 98 | 100 |
| 15 | 125 | 130 | 100 | 99 | 98 | 100 |
| 16 | 145 | 147 | 100 | 100 | 100 | 100 |
| 17 | 145 | 147 | 100 | 100 | 100 | 100 |
| 18 | 145 | 147 | 100 | 100 | 100 | 100 |

Table II shows that increased adhesion of the ink to the sheeting was observed as the temperature of the sheeting when the ink was applied was increased. Specifically, an increase in adhesion was seen when the prismatic sheeting was heated above 97° F. (36°).

### EXAMPLE 2

Another way to determine how well ink adheres to prismatic sheeting involves testing the peel force of the ink to the prismatic sheeting. Peel force was measured with a tensile test apparatus, such as the apparatus sold under the trade name “MTS-1122” manufactured by MTS Systems Corporation of Minnesota, United States. The tests were conducted with a 90 degree peel test fixture according to the procedure described in ASTM D-6862 Standard Test Method for 90 Degree Peel Resistance of Adhesives, using 1.0 inch (2.54 cm) wide adhesive tape manufactured by 3M Company under the trade designation “3M 390 Cloth Duct Tape.” A 0-200 lb. (0-90.7 kg) load cell was used with pull speeds of 16, 20, and 30 inches per minute (respectively 40.64, 50.8, and 76.2 centimeters per minute). The Traffic Yellow test pattern printed in Example 1 was tested. Test samples were prepared using a 0.025 inch (0.05 cm) 5052 H38 aluminum rigid adherend and conditioned at 70° F. (21° C.) with relative humidity of 70% for 12-24 hours. Table III below shows the average peel force recorded over at least 0.25 inch (0.63 cm) of pull for Traffic Yellow.

TABLE III
Degree Peel Resistance Test Results at Various Temperatures

| | Start | End | | | Peel |
|---|---|---|---|---|---|
| Test | Temp | Temp | Peel force at 16 | Peel Force at 20 | Force at 30 |
| Number | (° F.) | (° F.) | ipm (lbf/in) | ipm (lbf/in) | ipm (lbf/in) |
| 19 | 72 | 79 | 2.07 | 1.81 | 1.6 |
| 20 | 72 | 79 | 2.04 | 1.89 | 1.56 |
| 21 | 72 | 79 | 2.64 | 2.47 | 2.32 |
| 22 | 97 | 104 | 2.42 | 2.33 | 2.25 |
| 23 | 110 | 114 | 3.94 | 3.85 | 3.19 |
| 24 | 110 | 114 | 6.3 | 6.93 | 5.19 |
| 25 | 125 | 130 | 6.42 | 7.21 | 8.22 |
| 26 | 145 | 147 | 7.4 | 7.77 | 8.13 |
| 27 | 145 | 147 | 6.5 | 8.08 | 8.57 |

Table III shows that increased adhesion of the ink to the sheeting was observed as the temperature of the sheeting when the ink was applied was increased. Specifically, an increase in adhesion was seen when the prismatic sheeting was heated above 97° F. (36° C.).

### EXAMPLE 3

This example presents the degree peel resistance results for the Traffic Red signages prepared in Example 1. Table IV below shows the results of the degree peel resistance test for Traffic Red where the peel force is expressed in pound-force per inch.

TABLE IV
Degree Peel Resistance Test Results at Various Temperatures

| | Start | End | | | Peel |
|---|---|---|---|---|---|
| Test | Temp | Temp | Peel force at | Peel Force at 20 | Force at 30 |
| Number | (° F.) | (° F.) | 16 ipm (lbf/in) | ipm (lbf/in) | ipm (lbf/in) |
| 28 | 72 | 79 | 2.05 | 1.88 | 1.81 |
| 29 | 72 | 79 | 2.68 | 2.47 | 2.35 |
| 30 | 97 | 104 | 2.68 | 2.95 | 2.61 |
| 31 | 110 | 114 | 6.36 | 6.78 | 7.37 |
| 32 | 125 | 130 | 6.95 | 7.1 | 7.68 |
| 33 | 145 | 147 | 6.56 | 6.76 | 7.17 |
| 34 | 145 | 147 | 6.13 | 6.04 | 7.14 |

Table IV shows that increased adhesion of the ink to the sheeting was observed as the temperature of the sheeting when the ink was applied was increased. Specifically, an increase in adhesion was seen when the prismatic sheeting was heated above 97° F.

Results obtained with degree peel resistance test indicate “ink bond failure” (100% of the ink is transferred from the substrate to the tape), “adhesion failure” (where 100% of the ink remains on the substrate), and “mixed failure” (where part of the ink is transferred to the tape and part of the ink remains on the substrate). The inventors of the present application found that adhesion failure was typically observed at temperatures above 97° F. and that ink bond failure was typically observed at temperatures below 97° F. This supports the findings that adhesion of the ink to the sheeting was observed as the temperature of the sheeting when the ink was applied was increased.

### EXAMPLE 4

The inventors of the present application also tested the retroreflectivity of the imaged portions of the retroreflective sheeting. An acrylic-based overlay (manufactured by 3M Company and commercially available under the trade designation “TSS 1170NP”) was laminated to the printed retroreflective sheeting of Example 1 by a 16 inch (40.64 cm) wide laminator consisting of a 9 inch (22.86 cm) diameter steel hot can (heated to 125° F. (51.67° C.) and a 9 inch (22.86 cm) rubber nip roll. The laminator was operated at a setting of about 25-30 psi (170-207 Kilopascal (KPa)) of pressure applied to the nip roll with a 6 inch (15.24 cm) diameter air cylinder. The web line speed ranged from about 1.7 to about 2.0 feet per minute (from about 0.86 to about 1.01 cm/s).

Retroreflectivity of the printed retroreflective sheeting laminated with the overlay was measured according to ASTM E-810 Standard Test Method for Coefficient of Retroreflectivity, using an RM2 spectrometer manufactured according to ASTM E-810. Tables V-IX below show the results of the coefficient of retroreflectivity test for each of the four colors in the test pattern tested at, respectively, 72° F., 97° F., 110° F., 125° F., and 145° F. (respectively 22.2° C., 36.1° C., 43.3° C., 51.7° C. and 62.8° C.). Table X shows the average coefficient of retroreflectivity is expressed in units of candelas per lux per square meter (cd/lux.m²) for each color at each temperature. In Tables V-X, the coefficient of retroreflectivity is expressed in units of candelas per lux per square meter (cd/lux.m²). Also, the coefficient of retroreflectivity was only measured at one set of angles −5.0° entrance angle, 0.33° observation angle, 0° orientation angle and a 0° presentation angle with a 1 inch spot size.

TABLE V
Coefficient of Retroreflectivity Test Results at 72° F.

| Test | Coefficient of Retroreflectivity (cd/lux · m²) | | | | | | | |
|---|---|---|---|---|---|---|---|---|
| Number | Blue | | Orange | | Red | | Yellow | |
| 35 | 46.2 | 44 | 209 | 221 | 122 | 116 | 326 | 312 |
| 36 | 45.9 | 42.3 | 236 | 216 | 120 | 115 | 306 | 299 |
| 37 | 48.4 | 43.9 | 230 | 224 | 124 | 119 | 316 | 297 |
| 38 | 46.7 | 45.8 | 225 | 218 | 132 | 122 | 332 | 254 |
| 39 | 43.7 | 47.1 | 241 | 230 | 122 | 127 | 318 | 290 |
| 40 | 45 | 42.2 | 224 | 216 | 130 | 117 | 305 | 278 |
| 41 | 47.5 | 39.9 | 217 | 230 | 124 | 119 | 295 | 275 |
| 42 | 50.6 | 45.1 | 237 | 208 | 130 | 124 | 282 | 282 |
| 43 | 46.5 | 42.1 | 244 | 231 | 132 | 113 | 343 | 317 |
| 44 | 46.7 | 41.2 | 234 | 231 | 125 | 124 | 299 | 310 |

TABLE VI
Coefficient of Retroreflectivity Test Results at 97° F.

| | |
|---|---|
| | Coefficient of |
| Test | Retroreflectivity (cd/lux · m²) |

| Number | Blue | Orange | Red | Yellow |
|---|---|---|---|---|
| 45 | 50.4 | 232 | 140 | 365 |
| 46 | 51.3 | 252 | 138 | 339 |
| 47 | 52.3 | 265 | 134 | 362 |
| 48 | 46.3 | 245 | 137 | 352 |
| 49 | 54.1 | 253 | 138 | 350 |
| 50 | 47.9 | 262 | 143 | 356 |
| 51 | 51.8 | 247 | 135 | 357 |
| 52 | 49.6 | 267 | 130 | 346 |
| 53 | 49.6 | 265 | 136 | 335 |
| 54 | 52.3 | 250 | 138 | 335 |

TABLE VII
Coefficient of Retroreflectivity Test Results at 110° F.

| | |
|---|---|
| | Coefficient of |
| Test | Retroreflectivity (cd/lux · m²) |

| Number | Blue | Orange | Red | Yellow |
|---|---|---|---|---|
| 55 | 47.1 | 258 | 137 | 371 |
| 56 | 50.9 | 272 | 134 | 337 |
| 57 | 52.3 | 269 | 145 | 377 |
| 58 | 47.4 | 248 | 133 | 336 |
| 59 | 49.2 | 267 | 138 | 356 |
| 60 | 49.9 | 254 | 143 | 371 |
| 61 | 54.8 | 266 | 142 | 336 |
| 62 | 50.6 | 249 | 142 | 392 |
| 63 | 48.8 | 268 | 140 | 363 |
| 64 | 50.2 | 252 | 137 | 361 |

TABLE VIII
Coefficient of Retroreflectivity Test Results at 125° F.

| | |
|---|---|
| | Coefficient of |
| Test | Retroreflectivity (cd/lux · m²) |

| Number | Blue | Orange | Red | Yellow |
|---|---|---|---|---|
| 65 | 50.2 | 251 | 130 | 372 |
| 66 | 47.9 | 256 | 149 | 315 |
| 67 | 51.3 | 249 | 141 | 391 |
| 68 | 47.2 | 263 | 132 | 375 |
| 69 | 52.3 | 267 | 127 | 355 |
| 70 | 47.9 | 280 | 140 | 363 |
| 71 | 50 | 238 | 142 | 358 |
| 72 | 52.3 | 258 | 136 | 387 |
| 73 | 50.8 | 255 | 139 | 367 |
| 74 | 47.2 | 280 | 138 | 370 |

TABLE IX
Coefficient of Retroreflectivity Test Results at 145° F.

| | |
|---|---|
| | Coefficient of |
| Test | Retroreflectivity (cd/lux · m²) |

| Number | Blue | Orange | Red | Yellow |
|---|---|---|---|---|
| 75 | 43.7 | 220 | 109 | 345 |
| 76 | 40 | 225 | 104 | 280 |
| 77 | 43.5 | 235 | 111 | 313 |
| 78 | 38.1 | 222 | 109 | 272 |
| 79 | 42.5 | 197 | 105 | 336 |
| 80 | 41.2 | 217 | 105 | 310 |
| 81 | 44.6 | 242 | 113 | 327 |
| 82 | 40.7 | 213 | 107 | 265 |
| 83 | 39.2 | 220 | 111 | 327 |
| 84 | 42 | 232 | 100 | 292 |

TABLE X
Summary of Data From Tables V-IX

| | |
|---|---|
| | Average Coefficient of |
| Temperature | Retroreflectivity (cd/lux · m²) |

| (° F.) | Blue | Orange | Red | Yellow |
|---|---|---|---|---|
| 72 | 45 | 226 | 123 | 302 |
| 97 | 51 | 254 | 137 | 350 |
| 110 | 50 | 260 | 193 | 360 |
| 125 | 50 | 260 | 137 | 365 |
| 145 | 42 | 222 | 107 | 307 |

Tables V-X show that retroreflectivity of the portion of the sheeting including the cured image increases as the temperature of the sheeting when the ink was applied increases. Specifically, for blue, orange, and yellow, the average coefficient of retroreflectivity increases with increasing temperature until 145° F. at which time the average coefficient of retroreflectivity returns to around the same as a sheet printed at room temperature. For red, the coefficient of retroreflectivity decreases when the sheet is printed at 107°. Further, the coefficient of retroreflectivity at temperatures from 97° F. to 125° F. increases from 10 to 21%, depending upon color. These increases in retroreflectivity were unexpected beneficial results.

### EXAMPLE 5

The process of Example 1 was replicated except that the two UV lamps in the printer were operated in trailing “T” (matte) cure mode. Table XI shows the results of the percent adhesion test for each color that was applied to the prismatic sheeting at various temperatures.

TABLE XI
Adhesion by Tape Test Results at Various Temperatures

| Test | Start | End Temp | | | | |
|---|---|---|---|---|---|---|
| Number | Temp (° F.) | (° F.) | Red | Orange | Yellow | Blue |
| 85 | 102 | 111 | 92 | 0 | 0 | 88 |
| 86 | 102 | 111 | 94 | 3 | 12 | 95 |
| 87 | 102 | 111 | 92 | 1 | 0 | 90 |
| 88 | 113 | 119 | 99 | 50 | 8 | 99 |
| 89 | 113 | 119 | 98 | 98 | 75 | 99 |
| 90 | 113 | 119 | 99 | 97 | 45 | 99 |
| 91 | 127 | 130 | 100 | 99 | 97 | 100 |
| 92 | 127 | 130 | 100 | 98 | 97 | 100 |
| 93 | 127 | 130 | 100 | 98 | 97 | 100 |

Table XI shows that increased adhesion of the ink to the sheeting was observed as the temperature of the sheeting when the ink was applied was increased. Specifically, an increase in adhesion was seen when the prismatic sheeting was heated above 102° F. (38.9° C.).

Those having skill in the art will appreciate that many changes may be made to the details of the above-described embodiments and implementations without departing from the underlying principles thereof The scope of the present application should, therefore, be determined only by the following claims.

What is claimed is:

1. A method of forming a signage, comprising:
heating at least a portion of a retroreflective sheeting;
applying a UV-curable ink to the heated portion of the retroreflective sheeting; and
curing the UV-curable ink on the retroreflective sheeting.

2. The method of claim 1, further comprising:
applying a protective layer to the cured retroreflective sheeting.

3. The method of claim 2, wherein the protective layer has an index of refraction that differs from an index of refraction of the UV-curable ink by less than 10%.

4. The method of claim 1, further comprising:
attaching the cured retroreflective sheeting to a substrate.

5. The method of claim 1, wherein the UV-curable ink is applied by an ink jet printer.

6. The method of claim 1, wherein the retroreflective sheeting is heated to a temperature of at least 97° F.

7. The method of claim 1, wherein the UV-curable ink is self-crosslinking.

8. The method of claim 1, wherein the retroreflective sheeting is prismatic sheeting.

9. A signage formed by the method of claim 1.

10. A method of forming an imaged article, comprising:
heating at least a portion of a retroreflective substrate;
applying a radiation-curable ink to the heated portion of the retroreflective substrate; and
curing the ink.

11. The method of claim 10, wherein the retroreflective substrate is heated to a temperature of at least 97° F.

12. The method of claim 10, wherein applying the radiation-curable ink to the retroreflective substrate involves ink jet printing the ink onto the substrate.

13. The method of claim 10, further comprising:
applying a protective layer to the cured substrate.

14. The method of claim 13, wherein the protective layer has an index of refraction that differs from an index of refraction of the radiation-curable ink by less than 10%.

15. The method of claim 10, further comprising:
attaching the imaged article to a substrate.

16. A signage formed by the method of claim 10.

17. The method of claim 10, wherein the imaged article formed by heating the substrate and applying the radiation-curable ink has a coefficient of retroreflectivity that is equal to or greater than the coefficient of retroreflectivity of a substrate that was not heated before the radiation-curable ink was applied.

18. A method of forming an imaged article, comprising:
applying a radiation-curable ink to a retroreflective substrate that has a temperature of at least 97° F.; and
curing the ink.

19. A signage formed by the method of claim 18.
